(19) United States
(12) Patent Application Publication
(10) Pub. No.: US 2008/0265449 A1
(43) Pub. Date: Oct. 30, 2008

(54) Optical Master Substrate with Mask Layer and Method to Manufacture High-Density Relief Structure

(75) Inventors: Erwin Rinaldo Meinders, Eindhoven (NL); Rolf Antonie Loch, Enschede (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,831

(22) PCT Filed: Apr. 8, 2005
(86) PCT No.: PCT/IB05/51165

§ 371 Date: Oct. 11, 2006

(30) Foreign Application Priority Data
Apr. 15, 2004 (EP) 04101564.5

(51) Int. Cl. G02B 1/12; G11B 3/74

(52) U.S. Cl. 264/1.27; 369/94

(57) ABSTRACT

The invention relates to a master substrate, a method for making a high-density relief structure, and optical discs replicated with the high-density relief structure, the master substrate comprising a substrate layer (10) and a recording stack deposited on the substrate layer, the recording stack comprising:
a mask layer (12)
an interface layer (11) sandwiched between said mask layer and the substrate,
   said mask layer comprising a recording material for forming marks and spaces representing an encoded data pattern, said forming of marks by thermal decomposition by a focused laser beam and said marks having a different phase than the unrecorded material. A very high-density relief structure is achieved.

The present invention relates to an optical master substrate with mask layer for manufacturing a high-density relief structure. Such a relief structure can, for example, be used as a stamper for mass-replication of read-only memory (ROM) and pre-grooved write-once (R) and rewritable (RE) discs. The invention further relates to a method of manufacturing such a high-density relief structure. The invention further relates to the optical discs manufactured with the processed optical master substrate.

Optical record carriers have seen an evolutionary increase in the data capacity by increasing the numerical aperture of the objective lens and a reduction of the laser wavelength. The total data capacity was increased from 650 Mbyte (CD, NA=0.45, λ=780 nm) to 4.7 Gbyte (DVD, NA=0.65, λ=670 nm) to 25 Gbyte for the Blu-ray Disc (BD, NA=0.85, λ=405 nm). Optical record carriers can be of the type write-once (R), rewritable (RE) and read-only memory (ROM). The great advantage of ROM discs is the cheap mass replication, and therefore the cheap distribution of content such as audio, video and other data. Such a ROM disc is, for example, a polycarbonate substrate with tiny replicated pits (holes). The pits in a replicated disc can typically be made with injection molding or a similar kind of replication process. The manufacturing of a stamper, as used in such a replication process, is known as mastering.

In conventional mastering, a thin photosensitive layer, spin-coated on a glass substrate, is illuminated with a modulated focused laser beam. The modulation of the laser beam causes that some parts of the disc are being exposed by UV light while the intermediate areas in between the pits remain unexposed. While the disc rotates, and the focused laser beam is gradually pulled to the outer side of the disc, a spiral of alternating illuminated areas remains. In a second step, the exposed areas are being dissolved in a so-called development process to end up with physical holes inside the photo-resist layer. Alkaline liquids such as NaOH and KOH are used to dissolve the exposed areas. The structured surface is subsequently covered with a thin Ni layer. In a galvanic process, this sputter-deposited Ni layer is further grown to a thick manageable Ni substrate with the inverse pit structure. This Ni substrate with protruding bumps is separated from the substrate with unexposed areas and is called the stamper.

ROM discs contain a spiral of alternating pits and lands representing the encoded data. A reflection layer (metallic or other kind or material with different index of refraction coefficient) is added to facilitate the readout of the information. In most of the optical recording systems, the data track pitch has the same order of magnitude as the size of the optical readout/write spot to ensure optimum data capacity. Compare for example the data track pitch of 320 nm and the 1/e spot radius of 305 nm (1/e is the radius at which the optical intensity has reduced to 1/e of the maximum intensity) in case of Blu-ray Disc. In contrary to write-once and re-writable optical record carriers, the pit width in a ROM disc is typically half of the pitch between adjacent data tracks. Such small pits are necessary for optimum readout. It is well known that ROM discs are readout via phase-modulation, i.e. the constructive and destructive interference of light rays. During readout of longer pits, destructive interference between light rays reflected from the pit bottom and reflected form the adjacent land plateau occurs, which leads to a lower reflection level.

Mastering of a pit structure with pits of approximately half the optical readout spot typically requires a laser with a lower wavelength than is used for readout. For CD/DVD mastering, the Laser Beam Recorder (LBR) typically operates at a wavelength of 413 nm and numerical aperture of the objective lens of NA=0.9. For BD mastering, a deep UV laser with 257 nm wavelength is used in combination with a high NA lens (0.9 for far-field and 1.25 for liquid immersion mastering). In other words, a next generation LBR is required to make a stamper for the current optical disc generation. An additional disadvantage of conventional photoresist mastering is the cumulative photon effect. The degradation of the photo-sensitive compound in the photoresist layer is proportional to the amount of illumination. The sides of the focused Airy spot also illuminates the adjacent traces during writing of pits in the central track. This multiple exposure leads to local broadening of the pits and therefore to an increased pit noise (jitter). Also for reduction of cross-illumination, an as small as possible focused laser spot is required. Another disadvantage of photoresist materials as used in conventional mastering is the length of the polymer chains present in the photoresist. Dissolution of the exposed areas leads to rather rough side edges due to the long polymer chains. In particular in case of pits (for ROM) and grooves (for pre-grooved substrates for write-once (R) and rewritable (RE) applications) this edge roughness may lead to deterioration of the readout signals of the pre-recorded ROM pits and recorded R/RE data.

It is an object of the invention to provide a master substrate with mask layer for making a high-density relief structure, for example, for mass-replication of high-density read-only memory (ROM) and recordable (R/RE) discs with the advantage of a better signal quality of the pre-recorded data in ROM discs and a qualitatively better pre-groove for improved data recording (R/RE). In particular the use of a mask layer enables the making of a deep high-density relief structure, i.e. with a large aspect ratio. An object of the invention is further to provide a method of making such a high-density relief structure. Finally, the invention discloses optical discs made with the proposed master substrate and method of processing such a master substrate.

The object is achieved by providing a master substrate comprising a substrate layer and a recording stack deposited on the substrate layer, the recording stack comprising:

a mask layer,

an interface layer sandwiched between said mask layer and the substrate,

said mask layer comprising a recording material for forming marks and spaces representing an encoded data pattern, said forming of marks by thermal alteration by a focused laser beam and said marks having a different phase than the unrecorded material.

Preferred embodiments of the master substrate with mask layer are defined in the dependent claims. In a preferred embodiment, claimed in claim 2, the master substrate comprises a growth-dominated phase-change material, said material is an alloy comprising at least two materials of the group of materials containing Ge, Sb, Te, In, Se, Bi, Ag, Ga, Sn, Pb, As. In another preferred embodiment, the master substrate comprises a Sb—Te alloy material doped with Ge and In as recording material, in particular Sb₂Te doped with Ge and In. In another preferred embodiment, claimed in claim 4, the master substrate comprises a Sn—Ge—Sb-alloy material, in particular with the composition Sn_{18.3}—Ge_{12.6}—Sb_{69.2}. The claimed phase-change materials lead to so-called re-crystallisation in the tail of the mark enabling the further reduction of the channel bit length, and thus the tangential data density. The thickness range for the mask layer as claimed in claim 1 is defined in claim 5, namely 2-50 nm, preferably between 5 and 40 nm.

The preferred materials for the interface layer are claimed in claim 6, 7 and 8. Claim 6 discloses the use of dielectric materials, such as ZnS—SiO₂, Al₂O₃, SiO₂, Si₃N₄, as interface in the master substrate as claimed in claim 1. Claim 7 discloses the use of organic materials of the group dye materials containing phthalo-cyanine, cyanine and AZO dyes, as interface layer in the master substrate. Claim 8 discloses the use of organic photoresist materials selected from the group Diazonaphthoquinone-based resists as interface layer (11). The preferred thickness of the interface ranges from 5 nm to 200 nm, in particular between 20 and 110 nm, and is disclosed in claim 9.

In a preferred embodiment, the recording stack of the master substrate with mask layer as claimed in claim 1, further comprises a protection layer adjacent the mask layer at a side most remote from the substrate. The preferred thickness of this protection layer (81), disclosed in claim 11, is between 2 and 50 nm, in particular between 5 and 30 nm. The preferred materials are disclosed in claim 12 and 13. Claim 12 proposes the use of dielectric materials such as ZnS—SiO₂, Al₂O₃, SiO₂, Si₃N₄, Ta₂O. Claim 13 proposes the use of organic photoresist materials, in particular selected from the group Diazonaphthoquinone-based resists. Furthermore, the use of soluble organic materials, such as PMMA is disclosed. The protection layer is particularly advantageous to prevent large scale migration of molten phase-change material. This effect will be discussed later in the application. The protection layer needs to be resistant to the high recording temperatures that are encountered during writing the high-density relief structure in the master substrate. Another important requirement is the ability to remove this layer via etching with the proposed etching liquids. Other solvents are also possible to remove the cover layer, such as acetone, iso-propanol, etc. Even mechanical pealing off the protection layer is a possibility to remove it from the master substrate after recording.

In another preferred embodiment, the master substrate with mask layer as claimed in claim 1 further comprises a second interface layer between the substrate layer and the interface layer not facing the incident laser light. This interface layer preferably has a high resistance to the etching liquid such that this second interface acts as a natural barrier. The depth of the etched grooves and other relief structure is determined by the thickness of the mask layer and the first interface layer. The thickness of the second interface layer is claimed in claim 15, and ranges between 10 and 100 nm, preferably between 15 and 50 nm.

In another preferred embodiment, the master substrate as claimed in claim 1, 10 or 14 further comprises a metal heat sink layer (83) between the substrate layer and the interface layer, not facing the incident laser light. The metal heat sink is added for quick heat removal during recording of data. At the same time the metal heat sink layer can also serve as a reflector to enhance the absorption of the incident laser beam by the recording layer. The preferred thickness of the metallic layer is larger than 5 nm, in particular larger than 15 mm. The thickness range is disclosed in claim 17. The metal heat sink layer is made of a material or an alloy based on a material of the group of materials containing Al, Ag, Cu, Ag, Ir, Mo, Rh, Pt, Ni, Os, W and alloys thereof. These compositions are disclosed in claim 18.

The object is further achieved by providing a method of manufacturing a stamper for replicating a high density relief structure comprising at least the steps of
illuminating a master substrate as claimed in any one of claims 1-18 a first time with a modulated focused radiation beam,
rinsing the illuminated master substrate layer a first time with a developer, being one of an alkaline or an acid liquid, preferably selected of the group of solutions of NaOH, KOH, HCl and HNO3 in water, such that a desired first relief structure results,
sputter-deposition of a metallic layer, in particular a Nickel layer,
galvanically growing the sputter-deposited layer to the desired thickness forming a stamper,
separating the master substrate from the stamper.

The object is further achieved by providing a method as claimed in claim 19, further comprising the steps of:
after rinsing the master substrate the first time, illuminating the interface layer of the master substrate for a second time through the first relief structure, serving as a mask,
rinsing the illuminated master substrate layer a second time with a developer, being one of an alkaline or an acid liquid, preferably selected of the group of solutions of NaOH, KOH, HCl and HNO3 in water, such that the first relief structure is deepened to form a second relief structure.

A method as claimed in claim 19 using a master substrate as claimed in claims 1, 10, 14 or 16, the mask layer having a thickness in the range 5-35 nm wherein a pre-grooved shaped first relief structure is formed for replication of write-once and rewritable optical discs is disclosed in claim 21.

A method as claimed in claim 19 using a master substrate as claimed in claims 1, 10, 14 or 16, the mask layer having thickness in the range 5-35 nm wherein the second relief structure is formed in both the mask layer and the interface layer is disclosed in claim 22. In this embodiment, the recorded and patterned mask layer, with a thickness in the range 10-35 nm, serves as mask layer such that the relief structure is contained in both the mask layer and the interface layer. The interface layer etches at the places exposed to the etching liquid. The data pattern recorded in the mask layer is transferred via etching into the interface. After processing, the relief structure comprises the patterned mask layer and the etched interface layer.

A method as claimed in claim 19 using a master substrate as claimed in claim 1, the mask layer having a thickness in the range 5-35 nm, wherein the second relief structure is further deepened, by etching, to form a third relief structure such that the third relief structure is contained in the mask layer, the interface layer and partly in the substrate is disclosed in claim 23.

A method as claimed in any of the claims 18 to 23, in which the developer solution is used in a concentration 1-30%, preferably between 2 and 20% is claimed in claim 24.

Claim 25 discloses a pre-recorded optical disc replicated with the stamper manufactured with the method of any one of claims 19 to 24, characterized in that the relief structure on the stamper surface comprises shortest pits having a typical crescent and longer pits having a swallow-shaped trailing edge and that the relief structure is replicated in the optical disc.

The invention will now be explained in more detail with reference to the drawings in which

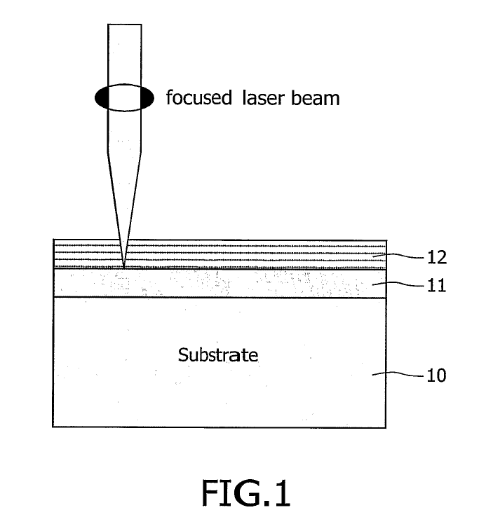

FIG. 1 shows the basic layout of the master substrate,

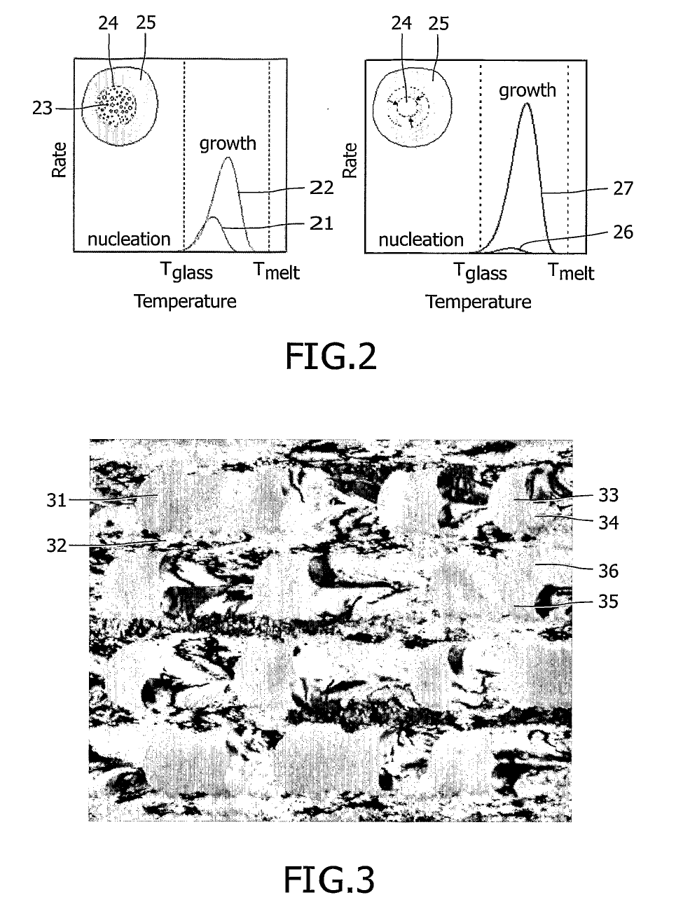

FIG. 2 shows nucleation and growth probabilities curves of two classes of phase-change materials: growth-dominated and nucleation-dominated phase-change materials,

FIG. 3 shows a Transmission Electron Microscopic (TEM) picture of written amorphous marks in an optical record carrier based on a fast-growth phase-change material,

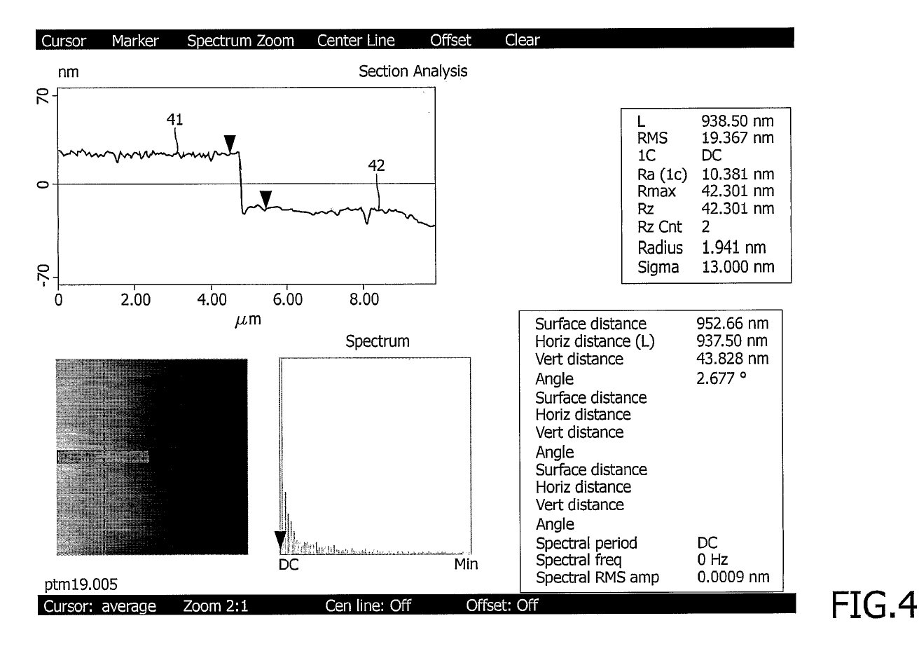

FIG. 4 shows an atomic force microscopy (AFM) picture of a relief structure illustrating the difference in etching velocity of the amorphous and crystalline phase,

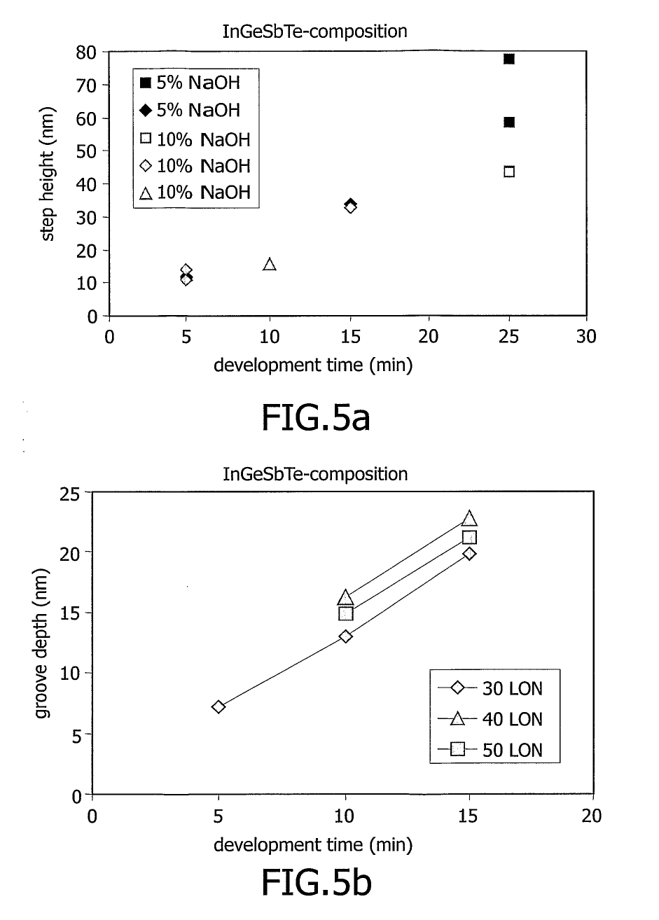

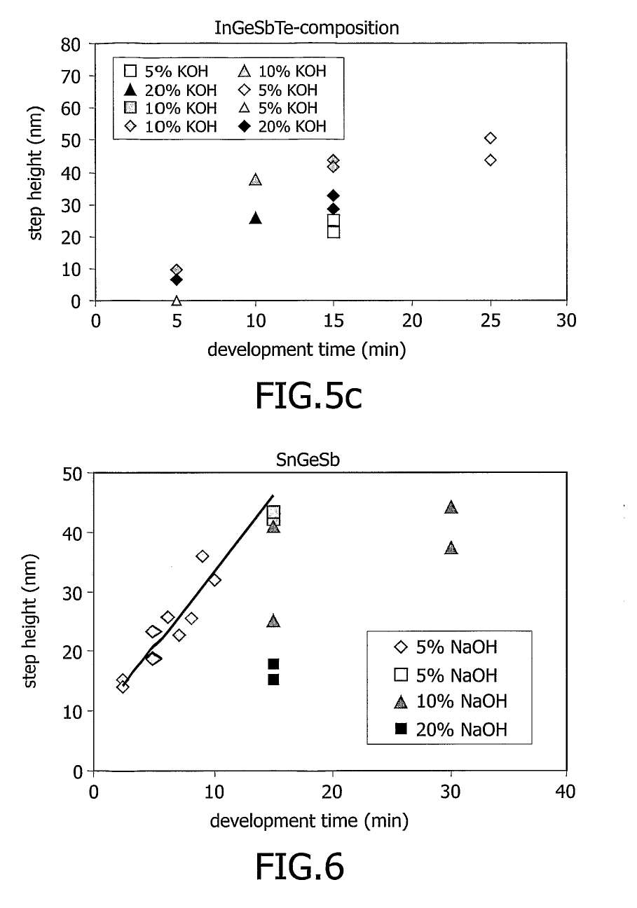

FIG. 5 shows the measured residual layer thickness as a function of the total dissolution time for an InGeSbTe phase-change composition in case NaOH and KOH are used as developer,

FIG. 6 shows the measured residual layer thickness as a function of the total dissolution time for a SnGeSb phase-change composition in case NaOH is used as developer,

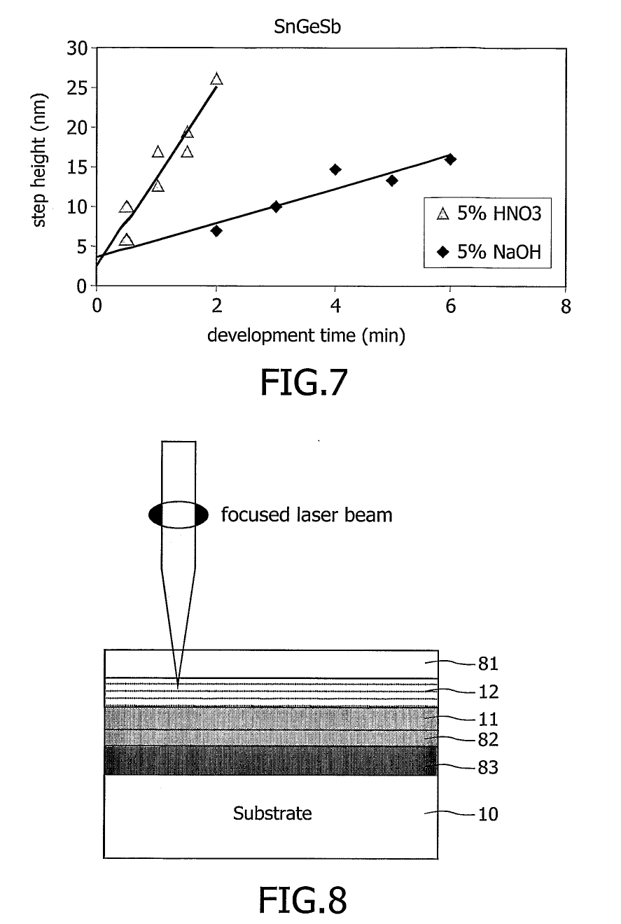

FIG. 7 shows the measured residual layer thickness as a function of the total dissolution time for a SnGeSb phase-change composition in case NaOH and HNO3 are used as developer,

FIG. 8 shows the layout of a preferred master substrate with mask layer,

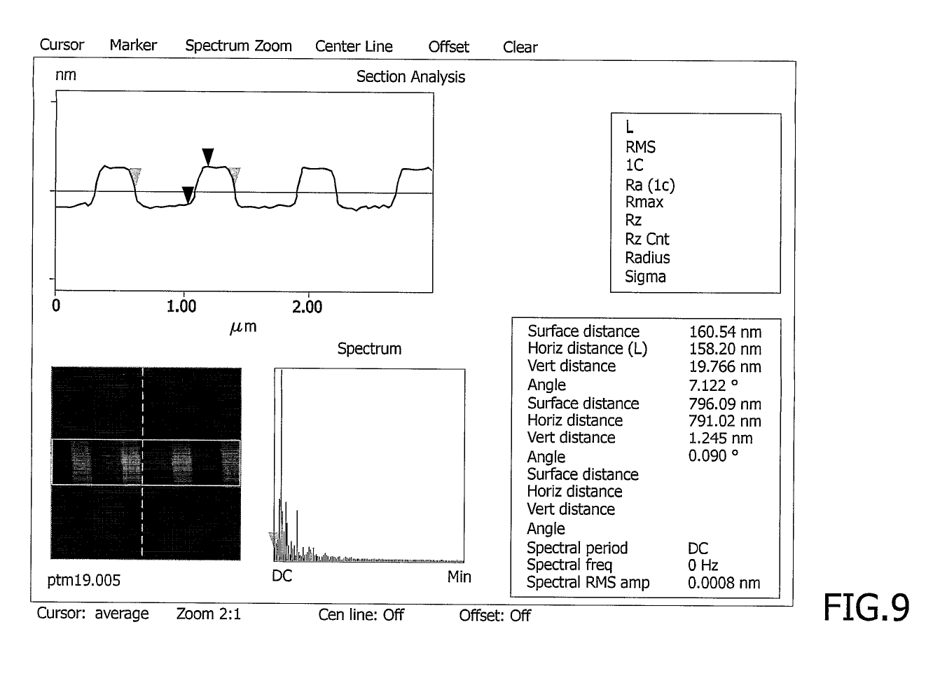

FIG. 9 shows a groove structure made with the proposed master substrate and according to the proposed method,

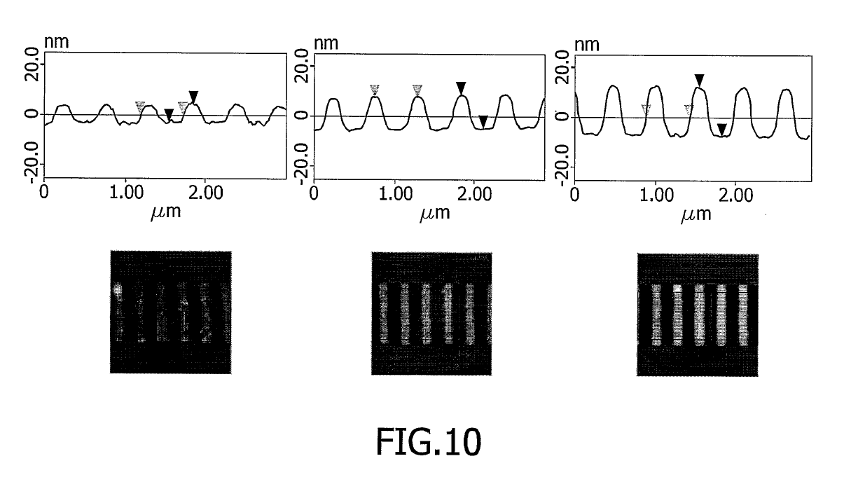

FIG. 10 shows three relief structures obtained for one laser power but immersed at different times in 10% NaOH solution,

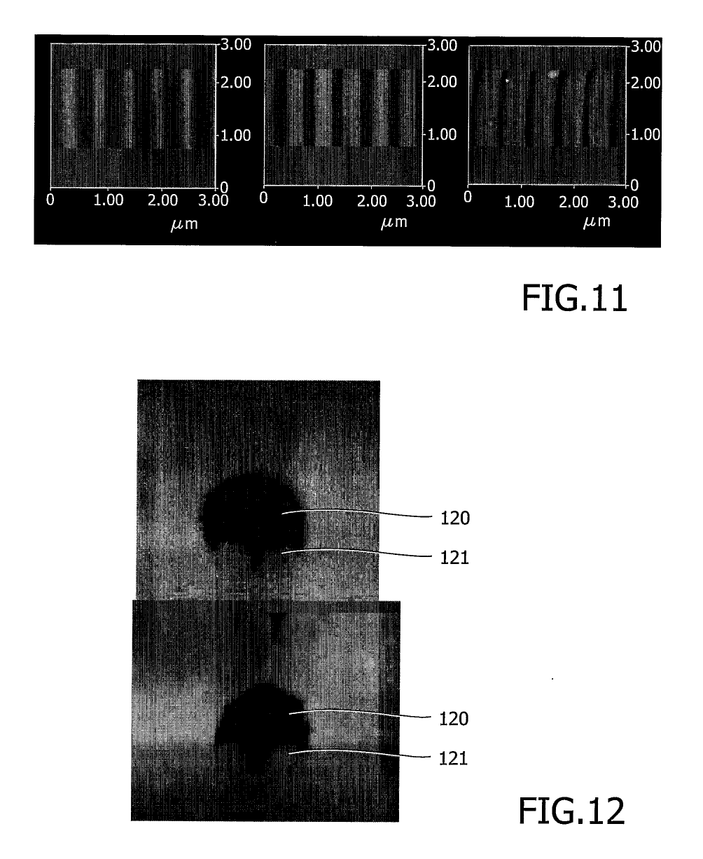

FIG. 11 shows three relief structure obtained for three different laser powers at 10 minutes immersion in 10% NaOH solution,

FIG. 12 shows AFM pictures of a short pit written with the proposed master substrate and according to the proposed method,

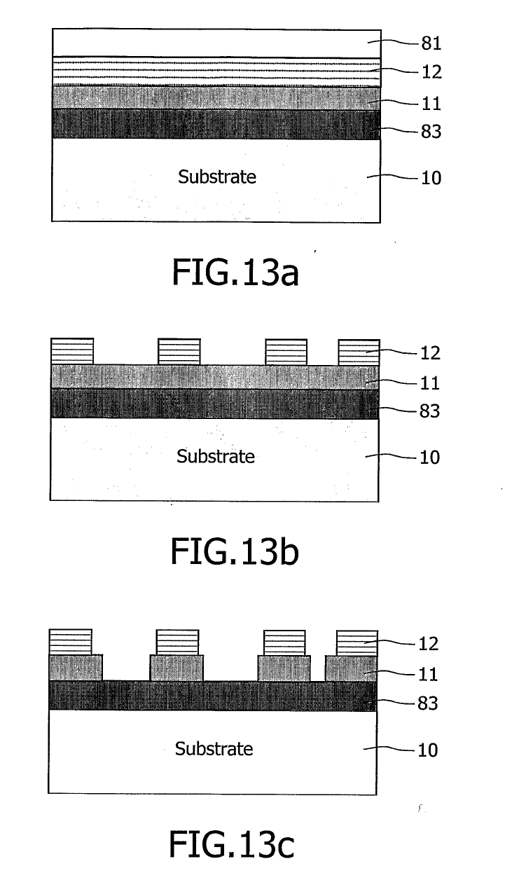

FIG. 13 shows schematically the process of using the mask layer to obtain a deeper high-density relief structure,

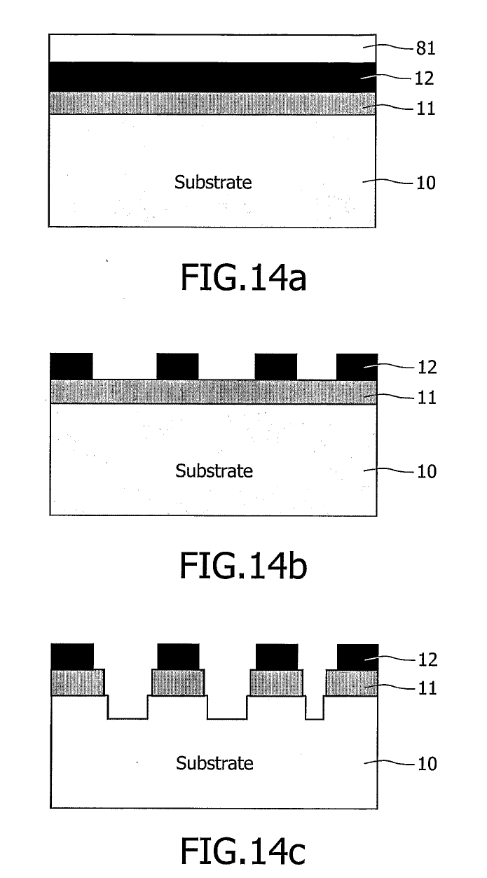

FIG. 14 shows schematically the process of using the mask layer to obtain an even deeper high-density relief structure.

Phase-change materials are applied in the well-known re-writable disc formats, such as DVD+RW and the recently introduced Blu-ray Disc (BD-RE). Phase-change materials can change from the as-deposited amorphous state to the crystalline state via laser heating. In many cases, the as-deposited amorphous state is made crystalline prior to recording of data. The initial crystalline state can be made amorphous by lased induced heating of the thin phase-change layer such that the layer melts. If the molten state is very rapidly cooled down, a solid amorphous state remains. The amorphous mark (area) can be made crystalline again by heating the amorphous mark to above the crystallisation temperature. These mechanisms are known from rewritable phase-change recording. The applicants have found that, depending on the heating conditions, a difference in etch velocity exists between the crystalline and amorphous phase. Etching is known as the dissolution process of a solid material in an alkaline liquid, acid liquid, or other type or solvent. The difference in etch velocity leads to a relief structure. Suitable etching liquids for the claimed material classes are alkaline liquids, such as NaOH, KOH and acids, such as HCl and HNO3. If the proposed phase-change materials are used as mask layer, the relief structure can be made deeper thereby leading to an larger aspect ratio. The aspect ratio is defined as the ratio of the height and the width of the obstacles of the relief structure. The relief structure can, for example, be used to make a stamper for the mass replication of optical read-only ROM discs and possibly pre-grooved substrates for write-once and re-writable discs. The obtained relief structure can also be used for high-density printing of displays (micro-contact printing).

In FIG. 1 the master substrate with mask layer proposed according to the present invention essentially comprises a mask layer (12) made of, for example phase-change material, and an interface layer (11) sandwiched between said mask layer (12) and the substrate (10). The phase-change material for use as recording material in said mask layer is selected based on the optical and thermal properties of the material such that it is suitable for recording using the selected wavelength. In case the master substrate in initially in the amorphous state, crystalline marks are recorded during illumination. In case the recording layer is initially in the crystalline state, amorphous marks are recorded. During developing, one of the two states is dissolved in the alkaline or acid liquid to result in a relief structure.

Phase-change compositions can be classified into nucleation-dominated and growth-dominated materials. Nucleation-dominated phase-change materials have a relative high probability to form stable crystalline nuclei from which crystalline marks can be formed. On the contrary, the crystallisation speed is typically low. An example of nucleation dominated materials are Ge1Sb2Te4 and Ge2Sb2Te5 materials. Growth-dominated materials are characterized by a low nucleation probability and a high growth rate. Example of growth-dominated phase-change compositions are the disclosed compositions Sb₂Te doped with In and Ge and SnGeSb alloy. The nucleation and growth probability curves of these two classes of phase-change materials are shown in FIG. 2. The left panel shows the crystallisation characteristics of a nucleation-dominated phase-change material. (21) indicates the probability of nucleation, (22) indicates the probability of growth. The material possesses a relatively high probability to form stable nuclei from which the amorphous material can crystallize to a polycrystalline mark. This re-crystallisation process is illustrated in the insert of the figure. The process of crystallisation from stable nuclei (23) of an amorphous mark (24) in a crystalline background (25) is schematically shown. The right panel shows the crystallisation characteristics of a growth-dominated phase-change material. (26) indicates the probability of nucleation, (27) indicates the probability of growth. These materials have a relatively low probability to form stable crystalline nuclei from which crystalline marks can be formed. On the contrary, the growth velocity is large such that re-crystallisation can be fast in case an amorphous-crystalline interface is present. The process is illustrated in the insert of the figure as well. The amorphous mark (24) re-crystallises via growth form the crystalline-amorphous interface.

In case crystalline marks are written in an initial amorphous layer, typical marks remain that are conform the shape of the focussed laser spot. The size of the crystalline mark can somewhat be tuned by controlling the applied laser power, but the written mark can hardly be made smaller than the optical spot. In case amorphous marks are written in a crystalline layer, the crystallisation properties of the phase-change material allow for a mark that is smaller than the optical spot size. In particular in case growth-dominated phase-change materials are used, re-crystallisation in the tail of the amorphous mark can be induced by application of proper laser levels at proper time scales relative to the time at which the amorphous mark is written.

This re-crystallisation process is elucidated in FIG. 3. Shown is a Transmission Electron Microscopy (TEM) picture of amorphous marks (31) written in a crystalline background layer (32). The used phase-change material was a growth-dominated phase-change material, specifically a Sb2Te composition doped with In and Ge. The shortest marks (33) are characterized by a so-called crescent shape due to the re-crystallisation induced in the trailing edge of the mark (34). The longer marks (35) show similar re-crystallisation behaviour in the trailing edge (36), also leading to shortening of the marks. This re-crystallisation enables the writing of marks smaller than the optical spot size.

A difference in dissolution rate of the amorphous and crystalline state is made visible in FIG. 4. The figure shows an atomic force microscopic picture of a relief structure that is obtained after rinsing a phase-change film, partly in the crystalline and partly in the amorphous state, with an alkaline solution (100% NaOH) for 10 minutes. The left plateau (41) refers to the initial (amorphous) state of the phase-change film. The right plateau (42) is the written (crystalline) state. A smooth step is found, which illustrates a good contrast in dissolution rate between the amorphous and crystalline phase of the used phase-change material (Sb₂Te doped with In and Ge).

Measured dissolution rates are shown in FIG. 5 for a Sb₂Te composition doped with In and Ge. FIG. 5a shows the measured residual layer thickness as a function of the total dissolution time for 5% and 10% concentrated NaOH solution. The slope of the curve denotes the dissolved layer thickness per unit time, which is denoted as the dissolution rate. For 5% NaOH, the dissolution rate is about 2 nm/minute for this particular InGeSbTe composition. For 10% NaOH, the dissolution rate is about 1.5 nm/minute for this particular InGeSbTe composition. FIG. 5b plots the measured groove depth as a function of the total dissolution time for 10% NaOH. The grooves were written with a laser beam recorder (LBR). Measurements are shown for three different laser powers (indicated with LON). The dissolution rate is also 1.5 nm/minute. FIG. 5c plots the measured groove depth as a function of the total dissolution time for 5, 10 and 20% KOH solution. The dissolution rate is about 1.3 nm/minute for 5% KOH, about 2 nm/minute for 20% KOH and about 3 nm/minute for 10% KOH.

The measured residual layer thickness as a function of the total dissolution time for 5%, 10% and 20% concentrated NaOH solution are given in FIG. 6 for a SnGeSb composition. The slope of the curve denotes the dissolved layer thickness per unit time, which is denoted as the dissolution rate. For 5% NaOH, the dissolution rate is about 2.3 nm/minute for this particular SnGeSb composition.

The measured residual layer thickness as a function of the total dissolution time for 5% HNO3 is compared to 10% NaOH in FIG. 7 for the SnGeSb composition. The dissolution rate of HNO3 is much higher than that for NaOH, namely 12 nm/minute versus 2.3 nm/minute.

The layout of an improved master substrate is given in FIG. 8. The recording stack comprises the mask layer (12) based on fast-growth phase-change materials, an interface layer (11), a second interface layer (82), a metallic heat sink layer (83) and a protection layer (81) on top of the mask layer. The metal heat sink layer is added to control the heat accumulation during writing of data and grooves. In particular if marks are written by amorphisation of the phase-change material, it is important that heat is quickly removed from the mask layer during recording to enable melt-quenching of the phase-change material. The protection layer is added to prevent large-scale migration of molten phase-change material under influence of centrifugal forces during rotation of the master substrate. The protection layer should be resistant to the high recording temperature of around 600-800 C in case of amorphous writing. Furthermore, the protection layer should be removable to form the relief structure in the mask layer and possibly in the interface layer (11) and substrate (10) as well.

Grooves made with the proposed master substrate and according to the proposed method are shown in FIG. 9. The grooves are written at a groove track pitch of 740 nm with a laser beam recorder, which was operated at a laser light wavelength of 413 nm and had an objective lens with numerical aperture of NA=0.9. The total dissolution time was 10 minutes in 20% NaOH solution. The resulting groove depth was 19.8 nm.

Another example of grooves made with the proposed master substrate and proposed method are shown in FIG. 10. Three different phases of the dissolution process are shown, namely the result after 5 (left image), 10 (middle image) and 15 (right image) minutes immersion in 10% NaOH. The grooves are written at a groove track pitch of 500 nm with a laser beam recorder which operates at a laser light wavelength of 413 nm and a numerical aperture of the objective lens of NA=0.9. The resulting groove depth was 20 nm after 15 minutes immersion.

Grooves written with different laser power of the LBR are shown in FIG. 11. The left image shows the result obtained at low laser power, the middle image shows the result obtained at medium laser power and the right image shows the result obtained at high laser power. The total dissolution time was 10 minutes with a 10% NaOH solution. The figure illustrates that the proposed master substrate and method enable the formation of grooves with different groove widths. The lowest power illustrates that a groove of width 160 nm can be written with a 413 nm LBR and NA=0.9, enabling the making of master substrates for replication of 25 GB Blu-ray Disc RE (re-writable) and R (write-once) discs. The track pitch of the pre-recorded groove is TP=320 nm. A groove width of 160 nm gives a groove/land duty cycle of 50%. The width of the grooves can be further reduced if a laser beam recorder with 257 nm was used. A smaller optical spot will give a smaller thermal spot and therefore narrower written grooves. The smaller spot will also facilitate the writing of smaller marks, and therefore will lead to higher data densities.

AFM pictures of a short pit written with the proposed master substrate and according to the proposed method are given in FIG. 12. The total dissolution time was 10 minutes in 10% NaOH solution. The pit is denoted with (120). The pit shape resembles the typical crescent shape of the shortest marks shown in FIG. 2. The pit width is almost twice the length of the pit. The pit length is reduced via the re-crystallization effect in the tail of the pit (121). The crescent shape of the mark is perfectly transferred to the relief structure. The depth of the pit was 20 nm in this case.

The examples illustrate that fast-growth phase-change materials possess a high contrast in dissolution rate between the amorphous and the crystalline phase. This contrast in dissolution rate can be utilized to make a high-density relief structure in the mask layer. The high-density relief structure can be contained in the mask layer only, but also in the mask layer and interface layer (11). Interface layer (82) acts as a natural barrier to etching since it is designed to have a very low or zero dissolution rate for the used developer liquids, such as alkaline or acid liquids.

A high-density relief structure in the form of pre-grooves can be used as stamper for the replication of recordable (R) and rewritable (RE) optical discs. A high-density relief structure in the form of pre-pits can be used as stamper for the replication of pre-recorded read-only memory (ROM) discs. In particular in the latter case, the typical crescent shapes that result from writing in fast-growth phase-change materials, are present in the high-density relief structure, and eventually will be transferred into the optical ROM disc via replication.

It is possible to use the patterned mask layer with relief structure as a mask layer for further development of the underlying layer. Further development means the further selectively removal of material from the master substrate, in particular from the interface layer, for obtaining a deeper relief structure. This process is schematically shown in FIG. 13. The upper figure (FIG. 13a) shows the master substrate with protection layer (81), mask layer (12), interface layer (11), metal layer (83) and substrate (10). After illumination and developing (patterning) of the mask layer (12), the result given in FIG. 13b, the etching liquid can come in contact with the interface layer (11) as well. Selective exposure of the interface layer to the etching fluid will cause that the relief structure embedded in the mask layer is further transferred into the interface layer (11). This is schematically shown in FIG. 13c. The great advantage of this embodiment is to obtain deep relief structures. The etching liquid used for etching the interface layer may be of a different type than that used to pattern the mask layer.

In case no metallic layer (83) is used, the relief structure can be further etched into the substrate to obtain a further deepening of the relief structure. This process is schematically shown in FIG. 14. The master substrate comprises a protection layer (81), a mask layer (12), an interface layer I1 and substrate (10). After illumination and developing (patterning) of the mask layer (12), the result given in FIG. 14b, the etching liquid can come in contact with the interface layer (11) as well. Selective exposure of the interface layer to the etching fluid will cause that the relief structure embedded in the mask layer is further transferred into the interface layer (11) and substrate (10). This is schematically shown in FIG. 14c. The great advantage of this embodiment is to obtain even deeper relief structures.

It is also possible to use the patterned mask layer with relief structure as a mask layer for further illumination of the interface layer I1. The interface layer I1 is, for example, made of a photosensitive polymer. Illumination of the master substrate with for example UV light will cause exposure of the areas which are not covered with the mask layer. The areas of the interface layer covered with the mask layer are not exposed to the illumination since the mask layer is opaque for the used light. The exposed interface layer I1 can be treated in a second development step, with a developing liquid not necessarily be the same as the liquid used to pattern the mask layer. In this way, the relief structure present in the mask layer is transferred to the interface layer I1 such that a deeper relief structure is obtained.

The proposed master substrate with protection layer is also perfectly suited for mastering with liquid immersion. Liquid immersion mastering is a mastering concept to increase the numerical aperture of the objective lens to above 1. Water is present as an intermediate medium in between the objective lens and the master substrate instead of air. Water has a higher index of refraction (n) than air. In the preferred mastering method, a temperature increase of at least 500-800 is required to induce melting of the phase-change layer. In particular in case a liquid film is present on top of the phase-change layer, a significant amount of heat will be lost through the liquid film. This heat loss leads to:

1) a very higher laser power for recording data. In most laser beam recorders, the available laser power is limited. Therefore, a significant heat loss is not permitted.
2) broadening of the thermal write spot. This is explained from the lateral heat spreading due to the presence of a good thermal conductor in the vicinity of the mask layer. The size of the focused laser spot is determined by the optics of the system. This focused laser spot causes laser-induced heating by the absorption of photons in the recording stack. In case a good thermal conductor is present in the vicinity of the mask layer, lateral spreading will cause a broadening of the temperature distribution. Since the proposed method is based on thermally induced phase transitions, this temperature broadening leads to larger marks and leads to a reduced data density.

The proposed protection layer acts as a good insulator, preventing the heat loss from the mask layer. In case such a protection layer is applied, the optical spot resembles almost the thermal spot such that small marks can be written. The thermal conductivity of the proposed organic protection layers is between 0.2 and 0.4 W/mK.

An additional advantage is the protection against water of the mask layer. The protection layer can be seen as a seal during liquid immersion mastering.

1. A master substrate comprising a substrate layer (10) and a recording stack deposited on the substrate layer, the recording stack comprising:
a mask layer (12)
an interface layer (11) sandwiched between said mask layer and the substrate,
said mask layer comprising a recording material for forming marks and spaces representing an encoded data pattern, said forming of marks by thermal decomposition by a focused laser beam and said marks having a different phase than the unrecorded material.

2. A master substrate as claimed in claim 1, wherein said recording material is a growth-dominated phase-change material, said material is an alloy comprising at least two materials of the group of materials containing Ge, Sb, Te, In, Se, Bi, Ag, Ga, Sn, Pb, As.

3. A master substrate as claimed in claim 1, wherein said recording material is a Sb—Te alloy material, in particular Sb₂Te doped with Ge and In.

4. A master substrate as claimed in claim 1, wherein said recording material is a Sn—Ge—Sb-alloy material, in particular with the composition Sn_{18.3}—Ge_{12.6}—Sb_{69.2}.

5. A master substrate as claimed in claim 1, wherein said mask layer (12) has a thickness in the range from 2 nm to 50 nm, preferably between 5 and 40 nm.

6. A master substrate as claimed in claim 1, wherein said interface layer (11) is made of a material of the group of dielectric materials containing ZnS—SiO₂, Al₂O₃, SiO₂, Si₃N₄.

7. A master substrate as claimed in claim 1, wherein said interface layer (11) comprises at least one organic dye selected from the group phthalo-cyanine, cyanine and AZO dyes.

8. A master substrate as claimed in claim 1, wherein said interface layer (11) comprises an organic photoresist selected from the group Diazonaphthoquinone-based resists.

9. A master substrate as claimed in claim 1, wherein said interface layer (11) has a thickness in the range from 5 nm to 200 nm, in particular between 20 and 110 nm.

10. A master substrate as claimed in claim 1, wherein the recording stack further comprises a protection layer (81) adjacent the mask layer (12) at a side most remote from the substrate.

11. A master substrate as claimed in claim 10, wherein said protection layer (81) has a thickness between 2 and 50 nm, in particular between 5 and 30 nm.

12. A master substrate as claimed in claim 10, wherein said protection layer (81) is made of the group dielectric materials containing ZnS—SiO₂, Al₂O₃, SiO₂, Si₃N₄, Ta₂O.

13. A master substrate as claimed in claim 10, wherein said protection layer (81) comprises an organic material, in particular selected from the group Diazonaphthoquinone-based photoresists, or from the group soluble organic materials, like PMMA.

14. A master substrate as claimed in claim 1, wherein the recording stack further comprises a second interface layer (82) between said substrate layer and said interface layer (11).

15. A master substrate as claimed in claim 14, wherein said second interface layer (82) has a thickness between 10 and 100 nm, preferably between 15 and 50 nm.

16. A master substrate as claimed in claim 1, wherein a metal heat sink layer (83) is present between said substrate layer and said interface layer (11) or (82).

17. A master substrate as claimed in claim 16, wherein said metal heat sink layer (83) has a thickness larger than 5 nm, in particular larger than 15 nm.

18. A master substrate as claimed in claim 16, wherein said metal heat sink layers (83) comprises a material selected from the group of materials Al, Ag, Cu, Ag, Ir, Mo, Rh, Pt, Ni, Os, W and alloys thereof.

19. A method of manufacturing a stamper for replicating a high density relief structure comprising at least the steps of
illuminating a master substrate as claimed in any one of claims 1-18 a first time with a modulated focused radiation beam,
rinsing the illuminated master substrate layer a first time with a developer, being one of an alkaline or an acid liquid, preferably selected of the group of solutions of NaOH, KOH, HCl and HNO3 in water, such that a desired first relief structure results,
sputter-deposition of a metallic layer, in particular a Nickel layer,
galvanically growing the sputter-deposited layer to the desired thickness forming a stamper,
separating the master substrate from the stamper.

20. A method as claimed in claim 19, further comprising the steps of
after rinsing the master substrate the first time, illuminating the interface layer of the master substrate for a second time through the first relief structure, serving as a mask,
rinsing the illuminated master substrate layer a second time with a developer, being one of an alkaline or an acid liquid, preferably selected of the group of solutions of NaOH, KOH, HCl and HNO3 in water, such that the first relief structure is deepened to form a second relief structure.

21. A method as claimed in claim 19 using a master substrate comprising a substrate layer (10) and a recording stack deposited on the substrate layer, the recording stack comprising:
a mask layer (12)
an interface layer (11) sandwiched between said mask layer and the substrate,
said mask layer comprising a recording material for forming marks and spaces representing an encoded data pattern, said forming of marks by thermal decomposition by a focused laser beam and said marks having a different phase than the unrecorded material, the mask layer (12) having a thickness in the range 5-35 nm wherein a pre-grooved shaped first relief structure is formed for replication of write-once and rewritable optical discs.

22. A method as claimed in claim 19 using a master substrate comprising a substrate layer (10) and a recording stack deposited on the substrate layer, the recording stack comprising:
a mask layer (12)
an interface layer (11) sandwiched between said mask layer and the substrate,
said mask layer comprising a recording material for forming marks and spaces representing an encoded data pattern, said forming of marks by thermal decomposition by a focused laser beam and said marks having a different phase than the unrecorded material, the mask layer (12) having thickness in the range 5-35 nm wherein the second relief structure is formed in both the mask layer (12) and the interface layer (11).

23. A method as claimed in claim 19 using a master substrate comprising a substrate layer (10) and a recording stack deposited on the substrate layer, the recording stack comprising:
a mask layer (12)
an interface layer (11) sandwiched between said mask layer and the substrate,
said mask layer comprising a recording material for forming marks and spaces representing an encoded data pattern, said forming of marks by thermal decomposition by a focused laser beam and said marks having a different phase than the unrecorded material, the mask layer (12) having a thickness in the range 5-35 nm, wherein the second relief structure is further deepened, by etching, to form a third relief structure such that the third relief structure is contained in the mask layer (12), the interface layer (11) and partly in the substrate (10).

24. A method as claimed in claim 19, in which the developer solution is used in a concentration 1-30%, preferably between 2 and 20%.

25. A pre-recorded optical disc replicated with the stamper manufactured with the method of claim 19, characterized in that the relief structure on the stamper surface comprises shortest pits having a typical crescent and longer pits having a swallow-shaped trailing edge and that the relief structure is replicated in the optical disc.
